(19) United States
(12) Patent Application Publication
(10) Pub. No.: US 2026/0098521 A1
(43) Pub. Date: Apr. 9, 2026

(54) DRIVE TRAIN FOR A WIND TURBINE AND SERIES OF DRIVE TRAINS

(71) Applicant: Flender GmbH, 46395 Bocholt (DE)

(72) Inventor: RALF HAMBRECHT, Bocholt (DE)

(73) Assignee: Flender GmbH, 46395 Bocholt (DE)

(21) Appl. No.: 19/114,274

(22) PCT Filed: Sep. 4, 2023
(86) PCT No.: PCT/EP2023/074110

§ 371 Date: Mar. 21, 2025

(30) Foreign Application Priority Data
Sep. 23, 2022 (EP) 22197290.4

(51) Int. Cl. F03D 80/70; F03D 15/10

(52) U.S. Cl. CPC F03D 80/703; F03D 15/101; F05B 2240/54

(57) ABSTRACT

A drive train designed for a requirement profile includes a transmission to transmit and convert torque from a rotor shaft of a rotor. The transmission includes an Input transmission component which is unmounted on a rotor side for introducing the torque into the transmission and which partially protrudes on the rotor side out of a transmission housing and/or a ring gear of the transmission. The drive train further includes a coupling unit which is separate from the rotor shaft, from the rotor bearing arrangement and from the transmission, for permitting a torque-transmitting and rotationally rigid coupling of the rotor shaft to the input transmission component within the coupling unit. The coupling unit includes a bearing to mount the unmounted input transmission component within the coupling unit, with the input transmission component being mounted on the rotor side exclusively only by the bearing within the coupling unit.

### DESCRIPTION

The invention relates to a drive train for a wind turbine, which can be used to transmit a torque from a rotor of the wind turbine to a generator of the wind turbine. The invention also relates to a type series of such drive trains.

In wind turbines, use is made of different drive train concepts for a variety of requirement profiles and a variety of generator concepts. For example, an offshore wind turbine is subjected to much higher wind loads than an inland wind turbine is, and therefore, in the transmissions used for the respective wind turbine, mechanical support which is stronger or less strong should be provided. Moreover, generators with different concepts may provide different input speeds, and that places different requirements on the speed ratio of the transmission. Moreover, it is possible that a more or less flexible attachment of a rotor shaft of the rotor of the wind turbine to the transmission is required, for example to damp oscillations by adjusting the rotor blades. The result of this is that the transmission of a wind turbine must be individually configured for the specific intended use and therefore, owing to the associated structural adaptation of the transmission, the production costs are high.

EP 3 767 102 A1 discloses torque-transmittingly connecting a transmission of a wind turbine to a rotor shaft of a rotor of the wind turbine via a rotationally rigid coupling.

WO 2007/085644 A1 and EP 3 232 055 A1 each disclose providing a rotor-shaft bearing of a rotor shaft of a rotor of a wind turbine inside a transmission housing of a transmission of the wind turbine.

US 2020/0291927 A1 discloses coupling a wind turbine wind-rotor shaft mounted in a main bearing of a rotor bearing arrangement to an output shaft via an elastic coupling in the form of a curved toothing or an elastic element, so that it is possible to allow an offset and tilting of the output shaft relative to the rotor shaft and its rotor bearing arrangement.

US 2011/0143880 A1 discloses allowing a wind turbine wind-rotor shaft mounted in a main bearing of a rotor bearing arrangement to protrude into a transmission via a bearing provided on a transmission housing of the transmission, or fastening the rotor shaft, which is only mounted in the rotor bearing arrangement, to a rotatable ring gear of a planetary transmission via a mounted slip clutch to delimit the torque that is to be transmitted.

In US 2013/0300125 A1, a wind turbine wind-rotor shaft mounted in a main bearing of a rotor bearing arrangement is coupled to a planet carrier provided completely in a transmission housing of a transmission via a curved-tooth coupling, the planetary transmission being mounted on the rotor side within the transmission housing.

WO 2007/085644 A1 discloses coupling a wind turbine wind-rotor shaft mounted in a main bearing of a rotor bearing arrangement to a planet carrier, provided completely in a transmission housing supported via a torque arm, via a curved-tooth coupling flange-mounted on the rotor shaft.

The object of the invention is to disclose measures which enable a cost-effective drive train for a wind turbine.

The object is achieved by a drive train having the features of claim 1, a type series having the features of claim 12, a type series having the features of claim 14, and a data agglomerate having the features of claim 15. Preferred configurations, which may each individually or together represent an aspect of the invention, are specified in the dependent claims and the following description. If a feature is presented together with another feature, this serves only for simplified presentation of the invention and is in no way intended to mean that this feature cannot also be a refinement of the invention without the other feature.

One aspect of the invention relates to a drive train for a wind turbine, comprising a transmission for transmitting and converting a torque originating from a rotor shaft, mounted in a rotor bearing arrangement, of a rotor, wherein the transmission has an input transmission component, in particular a planet carrier, which is unmounted at least on the rotor side and is intended for introducing the torque into the transmission, wherein the input transmission component partially protrudes on the rotor side out of a transmission housing and/or a ring gear of the transmission, and a coupling unit, which is separate from the rotor shaft, from the rotor bearing arrangement and from the transmission and is Intended for permitting a torque-transmitting and rotationally rigid, in particular form-fitting, coupling of the rotor shaft to the input transmission component within the coupling unit, wherein the coupling unit has a bearing for mounting the unmounted input transmission component within the coupling unit, wherein the input transmission component is mounted on the rotor side exclusively only by the bearing within the coupling unit.

The Input-side, in particular sole, mounting of the input transmission component of the transmission is effected not inside the transmission but outside the transmission. The rotor-side mounting of the unmounted input transmission component is effected not inside the transmission but exclusively outside the transmission in the separate coupling unit. In particular, the input-side mounting of the input transmission component in the axial direction is effected at an axial spacing from a transmission housing of the transmission. The input-side mounting of the input transmission component is effected, however, not on a rotor bearing housing of the rotor bearing arrangement or on the rotor shaft, but exclusively within the coupling unit using the at least one bearing provided in the coupling unit. The coupling unit is separate from the rotor shaft, from a rotor bearing housing, which mounts the rotor shaft, of the rotor bearing arrangement and from the transmission, and can constitute a structural unit formed separately from the rotor shaft, from the rotor bearing housing and from the transmission. The input transmission component, in particular the planet carrier, of the transmission is unmounted at least on the rotor side and is only mounted on the rotor side by means of the coupling unit, which is separate from the transmission. The input transmission component is mounted on the rotor side exclusively within the coupling unit. This means that it is not absolutely necessary to adapt the transmission to a variety of requirement profiles within the transmission; only the coupling unit is suitably adapted.

In this respect, it can be taken into account that depending on the requirement profile to be satisfied, the mounting of the input transmission component within the coupling unit can be modified to a different bearing diameter, in particular a different shaft diameter and/or connection diameter, and/or any required spring and/or damping elements can be provided at suitable locations in the torque flux between the rotor shaft and the input transmission component. The coupling unit can be prepared to provide a damping and/or coupling technique in accordance with the requirement profile that is to be satisfied and provide an input transmission component mounting which is suitable as a function of the mechanical loads to be expected. The coupling unit can thus act as a low-pass filter for static and/or dynamic loads and/or as a counterbearing for supporting tilt and/or yaw moments induced by the force exerted by the wind, with the result that downstream of the input transmission component in the torque flux, in spite of different requirement profiles, substantially comparable, in particular virtually identical, operating conditions and loads arise. Since substantially exclusively the coupling unit can provide the adaptation of the drive train to the requirement profile and individual adaptations within the transmission are no longer necessary, it is possible to reuse an already fully developed transmission design. The development costs and development times can be significantly reduced as a result. By adapting the mounting of the input transmission component within the separate coupling unit to various requirement profiles, it is possible to avoid changing the structure of the transmission, with the result that a cost-effective drive train for different wind turbines is enabled.

The respective requirement profiles can differ in particular in that, at least to a limited extent, different torques and/or different tilt and yaw moments, and/or different structural stiffnesses and/or different rotational speeds and/or different axial oscillations and/or different radial oscillations and/or different static and/or dynamic forces in the axial direction and/or in the radial direction and/or different lubrication requirements can arise. Two requirement profiles that are compared with each other can in this respect have only exactly one different requirement or two, three or more different requirements. The different requirement profiles come about in particular owing to different locations of a wind turbine that have different expected weather conditions and/or different rotor-blade diameters and/or different rotor-blade weights and/or different aerodynamic rotor-blade profiles and/or different control algorithms for operating the wind turbine and/or different generators for generating power that are provided and/or the way in which a rotor blade is adjusted.

The input transmission component is a functional component of the transmission which, in interaction with at least one further transmission component, can bring about a rotational speed ratio which given constant operating conditions is always different than i=1.0. A component of a coupling with a constant rotational speed, for example a spline toothing, an involute-spline toothing and/or a curved toothing, or a component of an elastic coupling, which permits only a limited variance in rotational speed around a mean value given constant operating conditions with the speed ratio i=1.0, is not understood to be a transmission component because it cannot convert the rotational speed. The input transmission component can have for example a toothing which meshes with the transmission and can be part of a spur gear toothing or part of a planetary transmission. With preference, the input transmission component is in the form of a planet carrier of a planetary transmission, on which planet gears at a radial spacing from the main axis of rotation are rotatably mounted, with the result that the rotational speed of the input transmission component can be converted by the planet gears, which mesh with a sun gear and/or a ring gear. With preference, the ring gear is fixed in terms of movement, and therefore the transmission, which is in the form of a planetary transmission, provides a step-up speed ratio. With preference, the transmission has more than one transmission stage, wherein the input-side input transmission component is part of the first transmission stage in the direction of the torque flux.

The bearing of the coupling unit is configured in particular to rotatably mount, relative to a preferably stationary coupling housing, that part of the input transmission component that is inserted in the coupling unit. In particular, the bearing is arranged at least partially in an axial region shared with the input transmission component. With preference, the bearing is provided completely inside the coupling housing of the coupling unit, in particular is rotationally fixedly fastened to the coupling housing. The bearing can, together with the coupling housing as a common structural unit, completely or partially form the coupling unit, which is separate from the transmission and separate from the rotor. The coupling unit is positioned in particular axially between a transmission housing of the transmission and a rotor bearing housing, provided for mounting the rotor shaft, of the rotor bearing arrangement. The rotor shaft protruding out of the rotor bearing housing of the rotor bearing arrangement and/or the input transmission component protruding from the transmission housing can be inserted, i.e. incorporated, at least partially in the coupling unit, in particular in the coupling housing. The bearing can be configured in particular to support tilt moments introduced via the rotor shaft and/or via the input transmission component. To this end, the bearing can be configured in particular to transfer significant axial loads. As a result, it is possible in particular that, for different drive-train concepts and different mountings of the rotor shaft, the transmission only needs to be designed for a particular torque that is to be transmitted, without it being necessary to compensate for different axial loads depending on the use case. It Is possible to compensate for different axial loads by suitably adapting the bearing in the coupling unit.

The rotor bearing arrangement is provided upstream of the transmission and the coupling unit in the torque direction. The rotor bearing arrangement has a stationary rotor bearing housing containing at least one rotor bearing which is also referred to as “main bearing” and by means of which the rotor shaft coupled to the (wind) rotor can be mounted. In particular, at least two axially spaced apart rotor bearings are provided. Generally speaking, the at least two rotor bearings are axially considerably spaced apart, in order to be able to support the very substantial loads exerted by the rotor. The rotor bearing and the rotor bearing housing of the rotor bearing arrangement are designed to support the dead weight of the rotor and of the rotor shaft and also the wind loads acting on the rotor during operation of the wind turbine. The rotor bearing arrangement is a structural unit separate from the transmission and from the coupling unit. The coupling unit is a separate structural unit different than the transmission and the rotor bearing arrangement. The rotor shaft can protrude, on an axial side facing away from the rotor, out of the rotor housing of the rotor bearing arrangement. The part protruding out of the rotor housing of the rotor bearing arrangement may be directly or indirectly coupled to the input transmission component, in particular the hub of a planet carrier. To this end, the rotor shaft can preferably partially dip into the coupling unit and, within the coupling unit, be coupled torque-transmittingly and rotationally rigidly, in particular fixedly and/or form-fittingly, to the input transmission component.

The coupling unit can allow the rotor shaft mounted by the rotor bearing arrangement to be torque-transmittingly coupled to the input transmission component within the coupling unit in this respect by the coupling unit providing enough structural space for the coupling of the rotor shaft to the input transmission component, and additionally providing accessibility for a tool in order to use the tool to bring about the coupling, for example a flanged-screw connection. Here, it is possible for the input transmission component to already be mounted in the bearing of the coupling unit when the torque-transmitting coupling to the rotor shaft is brought about, and that makes the assembly easier. It is, however, also possible for the input transmission component to only be moved, in particular drawn, into the bearing by the forces applied by means of the tool to establish the torque-transmitting coupling. This makes it easier to provide an interference fit inside the coupling unit between the input transmission component, which beforehand was unmounted on the rotor side, Le. input side, and the bearing of the coupling unit, and to press the input transmission component into the bearing of the coupling unit. The bearing of the coupling unit can as a result, when the rotor shaft is torque-transmittingly coupled to the input transmission component, be provided preassembled in the coupling unit and achieve a low-wear mounting of the input transmission component. Instead of directly connecting the transmission and the rotor bearing arrangement to one another and, to that end, needing to completely mount both the output side of the rotor bearing arrangement and the input side of the transmission, it is possible, by means of the coupling unit, which is separate from the rotor bearing arrangement and from the transmission, to indirectly connect the transmission to the rotor bearing arrangement, wherein the coupling unit together with the bearing for the input transmission component can be replaced cost-effectively, in order to adapt the transmission for a different requirement profile. The coupling unit is In particular shorter in the axial direction than in the radial direction. The coupling unit can preferably be plugged onto the input transmission component and/or onto the rotor shaft. The coupling unit performs not only the function of allowing the rotor shaft to be coupled to the input transmission component, but additionally the function of mounting the input transmission component and/or, in the form of an axially acting counterbearing, supporting the rotor shaft against wind loads. The coupling unit preferably provides the sole mounting of the input transmission component, so there is no need to provide a direct mounting of the input transmission component inside the housing. If appropriate, the input transmission component is captively retained in the transmission by the transmission housing. The rotor shaft can preferably partially dip into the coupling unit and, within the coupling unit, be coupled torque-transmittingly and rotationally rigidly, in particular fixedly and/or form-fittingly, to the input transmission component. In particular, the coupling between the rotor shaft and the input transmission element both unlimitedly transmits torque and is substantially fixed in terms of rotational speed. The coupling is in particular a form-fitting coupling, and therefore a frictional fit between the rotor shaft and the input transmission element that can be overcome under load is avoided.

The wind turbine in particular has a tower which is connected to the ground and on which a nacelle is provided. The drive train may be provided in the nacelle. The drive train may be fastened to the nacelle via a machine carrier, which can serve as a base. The rotor shaft connected to the coupling unit can protrude out of the nacelle and, outside of the nacelle, be connected to rotor blades via a rotor hub, in order to form the (wind) rotor of the wind turbine. An activation angle of the rotor blades can be modified in particular by means of a rotor blade controller, in particular in order to set the loads introduced via the rotor as a function of the current weather conditions and/or to avoid overloading. The input transmission component can protrude out of the transmission, in particular a transmission housing, on the input side, i.e. towards the rotor, and thus be easily coupled to the coupling unit.

The transmission may have an output transmission component, in particular a sun gear shaft, which faces toward a generator on the output side, i.e. away from the rotor. The output transmission component may protrude out of the transmission, in particular the transmission housing, and protrude into a generator housing of the generator, where the output transmission component of the transmission can be connected to a generator shaft of a rotor of an electric machine of the generator. As an alternative, the generator shaft of the generator can protrude into the transmission and, in particular inside the transmission housing, be connected to the output transmission component. The generator can generate electrical energy from the introduced torque, and this electrical energy can be supplied in particular to a power grid.

In particular, it is provided that the transmission has at least one planet stage with a planetary transmission and the input transmission component is a planet carrier of the planetary transmission facing the rotor shaft, wherein the planet carrier has a planet carrier hub protruding toward the rotor shaft, wherein the planet carrier hub is mounted in the coupling unit. The planetary gear carrier protruding from a planet carrier flank can be easily inserted into the coupling unit and directly or indirectly mounted within the coupling unit. The planetary gear hub can also protrude slightly out of a transmission housing of the transmission, with the result that it is not necessary to make any significant adaptations to the transmission in order to couple the coupling unit to the input transmission component. The torque coming from the rotor can be introduced into the respective planet stage via the planet carrier and discharged via a sun gear shaft, so that every planet stage can provide a high speed ratio in absolute terms. The planet carrier hub is formed in particular in one piece with at least one planet carrier flank of the planet carrier. The planet carrier can be at least roughly centered in the planetary transmission of the planet stage by the at least one planet gear that meshes with the sun gear and with the ring gear and roughly fixed in the relative position, it being possible to temporarily fix the planet carrier in place using at least one fixing element for transport and assembly. The mounting in the coupling unit by means of the bearing of the coupling unit is in this case sufficient to mount the planet carrier and fix its relative position inside the planet stage in defined fashion. The bearing in the coupling unit can be designed in such a way that deformations and displacements that are induced by the force exerted by the wind and come about between a connection of the rotor shaft in the coupling unit and a ring gear of the transmission can preferably be kept smaller than or identical to the permissible displacements in the previously developed core transmission intended for use as a transmission for a variety of drive trains. This behavior can advantageously be configured via the selected structural stiffness of the coupling unit and of the bearing preload and/or of the bearing clearance in the coupling unit.

The transmission may have exactly one transmission stage, in particular in the form of a planet stage, it preferably being possible for the transmission to have two, three, four or more transmission stages. The respective transmission stage has the respective planetary transmission, which can have as transmission components a sun gear, at least one planet gear meshing with the sun gear, a ring gear meshing with the planet gear, and a planet carrier which rotatably mounts the planet gear. The sun gear and a sun gear shaft connected to the sun gear, the planet carrier and the ring wheel are substantially coaxial with one another, the ring gear preferably being rotationally fixedly held, in particular fastened to the stationary transmission housing in fixed fashion in terms of movement, whereas the sun gear and the planet carrier are rotatably mounted, in particular on the transmission housing and/or on one another. The at least one planetary gear can be rotatably mounted on the planet carrier on a predefined radius relative to the axis of rotation of the transmission, which coincides with the axis of rotation of the sun gear and/or of the planet carrier. To this end, the at least one planet gear may be mounted on a planetary shaft fastened fixedly in terms of movement to the planet carrier or the respective planet gear has a planet-gear shaft which is fastened fixedly in terms of movement to the planet gear and is mounted in at least one planet-gear flank, preferably in a respective planet-gear flank at each of the two ends, of the planet carrier. With preference, three, five or seven planet gears in particular circumferentially uniformly distributed are provided.

It is preferably provided that the bearing bears directly against the input transmission component or the coupling unit has a transition piece, which is fixedly connected to the input transmission component and is intended for providing a bearing surface on a different bearing diameter than the input transmission component, wherein the bearing bears directly against the bearing surface of the transition piece. When the bearing of the coupling unit bears directly against the input transmission component, the input transmission component itself can form a bearing surface, to which for example a bearing ring of the bearing can be fastened. When the input transmission component is mounted only indirectly by the bearing of the coupling unit by means of the transmission piece, the transition piece can be fastened to the input transmission component and it is the transmission piece that forms the bearing surface for the bearing. The bearing surface of the transition piece is in this case provided on a bearing diameter which deviates from an outside and/or inside diameter of that part of the input transmission component that protrudes into the coupling unit. The input transmission component can as a result be mounted by means of the transition piece on a bearing diameter that is not provided at all in the input transmission component without a transition piece. This makes it possible to easily adapt the mounting of the input transmission component to a requirement profile which, due to the loads that arise and/or structural space restrictions, requires a bearing diameter which is not provided by the input transmission component alone. It is not necessary to adapt the input transmission component itself in this case. Depending on the requirement profile, a respective differently dimensioned transition piece can be installed in the coupling unit.

The bearing is particularly preferably in the form of a plain bearing or rolling bearing, in particular a tapered-roller bearing. Depending on the requirement profile, a plain bearing or a rolling bearing may be more suitable. Depending on the requirement profile, the bearing is configured to transfer, or deliberately not support, only radial forces, only axial forces or both axial and radial forces. The bearing may in particular be composed of multiple partial bearings, for example an axial bearing, in particular an axial plain bearing, and a radial bearing, in particular a radial plain bearing, or two tapered-roller bearings in a X arrangement or O arrangement. A structural space restriction for a particular desired mounting can be countered for example using the transition piece, even if the input transmission component has dimensions which are unfavorable for the desired mounting.

In particular, the coupling unit has at least one supporting foot for transferring mechanical loads to a stationary component, in particular a rotor bearing housing, provided for mounting the rotor shaft, of the rotor shaft arrangement and/or for transferring mechanical loads to a transmission housing and/or ring gear of the transmission and/or for transferring mechanical loads to a base for supporting the drive train. The supporting foot can be fastened to the stationary component in particular fixedly in terms of movement or be pressed against the stationary component due to the forces that are to be transferred. Mechanical loads can as a result at least partially be diverted past the input transmission component and transferred, so that the transmission is not overloaded even in the case of a demanding requirement profile. The supporting foot is provided in particular to transfer forces in the axial direction and/or in the radial direction.

With preference, the coupling unit has a torque arm for supporting the torque coming from the rotor shaft on a/the stationary component, in particular a rotor bearing housing, provided for mounting the rotor shaft, of the rotor shaft arrangement and/or for transferring mechanical loads to a transmission housing and/or ring gear of the transmission and/or for transferring mechanical loads to a base for supporting the drive train. The torque arm is provided in particular to transfer forces in the circumferential direction. The torque arm provided outside the transmission means that it is not necessary to provide a support for the torque in the transmission. Depending on the requirement profile, the torque arm of the coupling unit may be dimensioned for larger or smaller loads, without needing to make adaptations in the transmission for this.

The coupling unit particularly preferably has an axial spring element and/or an axial damper element for flexibly supporting axial forces, in particular those caused by the dead weight of the transmission. A weight force of the transmission can generate a tilt moment out of a radial plane of the transmission. This tilt moment can be supported by the axial spring element and/or an axial damper element of the coupling unit and tilting out of the radial plane can be prevented, or restricted to a tolerable extent. Depending on the installation situation of the transmission in the drive train and the requirement profile provided, a respective different tilting moment can occur. This can be absorbed via the adapted dimensions of the axial spring element and/or of the axial damper element, without needing to make adaptations within the transmission for this.

In particular, the coupling unit has an elastic coupling which is connectable to the rotor shaft, wherein the elastic coupling is rotationally rigid and axially and/or radially flexible. The elastic coupling can transmit the introduced torque virtually without losses, wherein axial and/or radial shocks can be damped and/or eliminated. For example, the elastic coupling has laminated cores and/or laminations which can be resilient in the axial and/or radial direction, but transmit a torque rotationally rigidly in the circumferential direction.

The coupling unit preferably has an in particular central passage opening for the passage of a pitch tube between the rotor shaft and the transmission. The pitch tube makes it possible to route in particular electric and/or hydraulic control lines for the operation of a rotor-blade adjustment means through the transmission, through the coupling unit and through the rotor shaft, in order to be able to adjust an activation angle of rotor blades connected to a rotor hub of the rotor shaft. The operation of a rotor-blade adjustment means is not significantly impaired by the coupling unit.

The coupling unit particularly preferably has a lubricant duct for swapping a lubricant, in particular lubricating oil, between the rotor shaft and the input transmission component. With preference, the lubricant can also be used to lubricate the bearing of the coupling unit and also be branched off of the lubricant duct via a lubricating duct provided for this purpose. The lubricant duct of the coupling unit also makes it possible to conjointly supply lubricant for the rotor and the transmission through the coupling unit. In particular, the dimensions of the flow cross section of the lubricant duct in the coupling unit make it possible to adapt a stream of lubricating oil to different requirement profiles, without needing to make changes to the lubrication concept within the transmission. A throttling effect of the lubricant duct in the coupling unit can be given a greater or lesser extent for this purpose.

In particular, the coupling unit has at least one rotor fastening means, which is accessible radially from the outside of the coupling unit and is intended for detachable fastening of the coupling unit to the rotor shaft, and/or at least one transmission fastening means, which is accessible radially from the outside of the coupling unit and is intended for detachable fastening of the coupling unit to the input transmission component of the transmission. The coupling unit can be preassembled with the transmission and easily fastened to the rotor shaft by means of the rotor fastening means. It is also possible for the coupling unit to be preassembled with the rotor shaft and easily fastened to the input transmission component using the transmission fastening means. The coupling element, for coupling the transmission to the rotor, preferably does not need to be preassembled with the rotor shaft or with the input transmission component, but instead can be fastened to the rotor shaft and to the input transmission component using the easily accessible rotor fastening means and transmission fastening means in accordance with an already established positioning of the transmission relative to the rotor. In particular, the transmission is relatively displaceably guided on a machine carrier in the axial direction of the rotor shaft, so that the input transmission component can be easily inserted into the coupling unit, which is for example already fastened to the rotor shaft, while a mechanic can closely monitor and, if appropriate, intervene in the threading of the input transmission component into the coupling unit. If the input transmission component is inserted in the coupling unit in the desired end position, the transmission fastening means can preferably be used to fix the relative position of the transmission with respect to the rotor.

One aspect of the invention relates to a type series of drive trains, comprising a first drive train, which can be formed and refined as described above and is designed for a first requirement profile, and a second drive train, which can be formed and refined as described above and is designed for a second requirement profile, wherein the transmission of the first drive train and the transmission of the second drive train are substantially identical and the coupling unit of the first drive train is different than the coupling unit of the second drive train. The type series can be formed and refined in particular as described above. By adapting the mounting of the input transmission component within the separate coupling unit to various requirement profiles, it is possible to avoid changing the structure of the transmission, with the result that a cost-effective drive train for different wind turbines is enabled.

With preference, the first drive train is connected to a first generator and the second drive train is connected to a second generator, wherein the first generator and the second generator are designed for different power profiles. This exploits the fact that the transmission can conform to exceedingly different output-side power profiles over a certain operating range. This makes it possible to adapt the drive train to the output-side power profile of the generator on the input side in the coupling unit. For example, a generator designed for a higher rated rotational speed can make it necessary to provide greater cooling in the transmission compared to a generator designed for a lower rated rotational speed, it being possible to take this cooling requirement into account by virtue of a lower throttling action when cooling oil is being conducted from the rotor shaft through the coupling unit into the transmission in the coupling unit. Different loads, in particular tilt moments that arise therefrom, whether the generator is supported on a base or machine carrier in the region of the generator or not, can be compensated for via the dimensions of the coupling unit, without it being necessary to make adaptations in the transmission for this. In addition, a change in the power profile of the generator, for example if there is a disruption on the grid side, can be absorbed by the coupling unit without it being necessary to make adaptations in the transmission for this. If the originally intended speed ratio of the transmission no longer matches on replacement of the generator, it is possible to provide, between the transmission and the generator, an in particular separately assemblable intermediate stage, for example a planet stage or spur-gear stage, without needing to modify the rest of the transmission. The transmission speed ratio can be selected cost-optimally for the generator torque and for the operating rotational speed of the generator. With this optimization, it is possible to take into account typical wind-rotor rotational speeds as a function of rotor diameter, wind classes, turbine power and blade-tip maximum velocities and typical maximum switching frequencies for electric components, in order to optimize costs.

A drive train of this type series can be easily used without adapting the transmission generator combination for different drive-train concepts and various requirement profiles, for example for onshore and offshore with associated better separability in the transport module and reduced logistics costs or sound-critical locations with or without a decoupling element.

A further aspect of the invention relates to a type series of drive trains, comprising a first generator designed for a first power profile and a first drive train which can be connected to the first generator, and a second generator designed for a second power profile and a second drive train which can be connected to the second generator, wherein the transmission of the first drive train and the transmission of the second drive train are substantially identical and the coupling unit of the first drive train is different than the coupling unit of the second drive train. The type series can be developed in particular as described above by means of the drive train and/or by means of the type series. This exploits the fact that the transmission can conform to exceedingly different output-side power profiles over a certain operating range. This makes it possible to adapt the drive train to the output-side power profile of the generator on the input side in the coupling unit. Different loads, in particular tilt moments that arise therefrom, whether the generator is supported on a base or machine carrier in the region of the generator or not, can be compensated for via the dimensions of the coupling unit, without it being necessary to make adaptations in the transmission for this. In addition, a change in the power profile of the generator, for example if there is a disruption on the grid side, can be absorbed by the coupling unit without it being necessary to make adaptations in the transmission for this. If the originally intended speed ratio of the transmission no longer matches on replacement of the generator, it is possible to provide, between the transmission and the generator, an in particular separately assemblable intermediate stage, for example a planet stage or spur-gear stage, without needing to modify the rest of the transmission. The transmission speed ratio can be selected cost-optimally for the generator torque and for the operating rotational speed of the generator. With this optimization, it is possible to take into account typical wind-rotor rotational speeds as a function of rotor diameter, wind classes, turbine power and blade-tip maximum velocities and typical maximum switching frequencies for electric components, in order to optimize costs.

A drive train of this type series can be easily used without adapting the transmission generator combination for different drive-train concepts and various requirement profiles, for example for onshore and offshore with associated better separability in the transport module and reduced logistics costs or sound-critical locations with or without a decoupling element.

By adapting the mounting of the input transmission component within the separate coupling unit to various input-side requirement profiles and/or output-side power profiles, it is possible to avoid changing the structure of the transmission, with the result that a cost-effective drive train for different wind turbines is enabled.

One aspect further relates to a data agglomerate comprising data packets which are combined in a common file or distributed across different files and are intended for representing the three-dimensional design and/or the interactions of all constituent parts provided in the drive train, which can be formed and developed as described above, wherein the data packets are prepared such that, when they are processed by a data processing device for operating an machine tool for additive manufacturing of apparatuses, to additively produce the constituent parts of the drive train, In particular by 3D printing, and/or, when they are processed by a data processing device for carrying out a technical simulation, to carry out a simulation of the functioning of the drive train and output thus generated simulation results for further use, in particular in order to provide a verification of the fatigue strength as a function of variable loads and/or variable thermal loading, and if appropriate to compare them with measurement data determined on an apparatus according to the invention that has been produced in reality and/or on a prototype of the apparatus according to the invention. The data packets of the data agglomerate are specially adapted to the configuration according to the invention of the apparatus in question according to the invention as described above, in order to be able to adequately represent the interaction according to the invention between the constituent parts of the apparatus according to the invention when they are processed in the data processing device. The data packets may in particular be stored with a spatial distribution, but may also be aligned with one another such that if all the data packets are brought together in a common data processing device, the thus composed data agglomerate provides all the required data for an additive manufacture and/or a technical simulation using the data processing device for the apparatus according to the invention. For example, the data packets are each separate parts of a data library, which are brought together to form the data agglomerate and aligned with one another with respect to their dimensions relative to one another and/or absolute dimensions and/or material properties corresponding to the apparatus in question according to the invention. The data agglomerate can represent a virtual embodiment of the apparatus in question according to the invention in the manner of what is referred to as a “digital twin”, which allows a virtual investigation in the form of a simulation or a real objectification by means of an additive manufacturing process. Such a digital twin is presented for example in US 2017/286572 A1, the disclosure contents of which are hereby referred to as part of the invention.

When the data processing device of the machine tool processes the data agglomerate, the apparatus according to the invention is produced such that, after the data agglomerate has been processed in the data processing device, the apparatus according to the invention is obtained, at least in the form of a prototype. In particular, a data packet can in each case represent a separate constituent part of the respective associated apparatus according to the invention, and therefore the individual constituent parts can be easily actually and/or virtually assembled in their relative position and/or relative movability to realize the interactions that are essential to the invention. In particular, it is possible, with the aid of the respective data packets, to generate the different constituent parts of the respective device separately and optionally from different materials by additive manufacturing and subsequently to assemble them to form a prototype of the apparatus in question. The division of the data of the data agglomerate into different data packets thus makes possible, in straightforward fashion, a sequential additive manufacture of constituent parts, which are movable relative to one another, of the apparatus in question in the form of a kit of parts, which is prepared for the interaction according to the invention of the constituent parts of the prototype for solving the problem addressed by the invention to be assembled merely as expedient.

Additionally or alternatively, it is possible, using the data packets of the data agglomerate, in a virtual environment during a technical simulation, to calculate and/or predict the individual constituent parts of the respective device and their interactions, the physical state and/or the change of physical parameters depending on different boundary conditions and/or over the time of the associated apparatus according to the invention and to continue to use them for checking whether the apparatus according to the invention is suitable enough for the intended use on the basis of the hypothetical configuration and taking into account the hypothetical simulated influences. When the data agglomerate is processed by a data processing device representing the simulation environment, it is possible to be able to investigate the behavior of the apparatus according to the invention, taking into account in particular changing boundary conditions. This makes it possible, for example, to Investigate centrifugal force effects on individual constituent parts of the apparatus according to the invention depending on different static and/or dynamic loads and/or different operating temperatures, with it being possible for such simulation results to be incorporated into the establishment of a fatigue strength verification. Preferably, the simulation results obtained after the data agglomerate has been processed in the data processing device for the simulation environment are stored in order to compare them with measurement data determined on an apparatus according to the invention that has been produced in reality and/or on a prototype of the apparatus according to the invention. This makes it possible to assess the quality of the simulation results obtained with the aid of the data agglomerate and/or, in particular in the case of particularly strong deviations, to identify measurement errors and/or an erroneous measurement. This simplifies and improves non-destructive quality control of the apparatus according to the invention.

The data agglomerate enables cost-effective production of prototypes and/or computer-based simulations to study the functioning of the rotary body and/or the holding tool, identify problems in the specific use case and find improvements. The solution to the problem addressed by the invention can be easily and cost-effectively checked using the data agglomerate.

The invention is explained below by way of example with reference to the accompanying drawings using preferred exemplary embodiments, wherein the features presented below can each represent an aspect of the invention both individually and in combination. It is shown in:

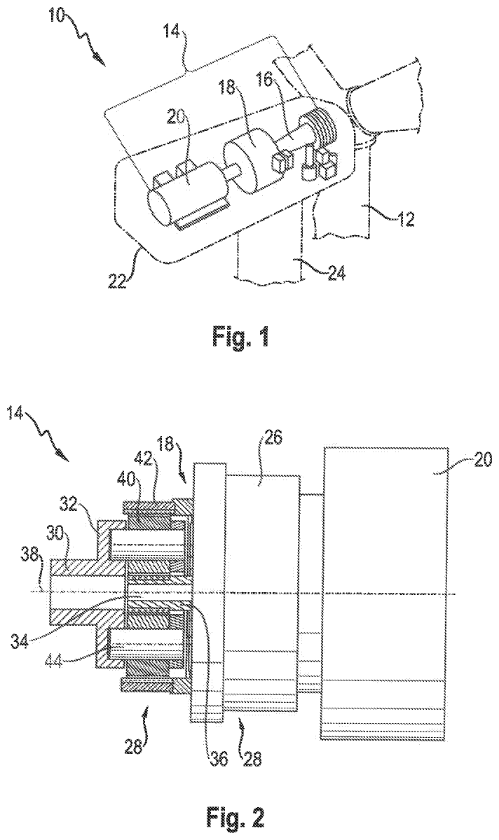

FIG. 1; a schematic perspective view of a wind turbine,

FIG. 2: a schematic side view of a part of a drive train of the wind turbine from FIG. 1,

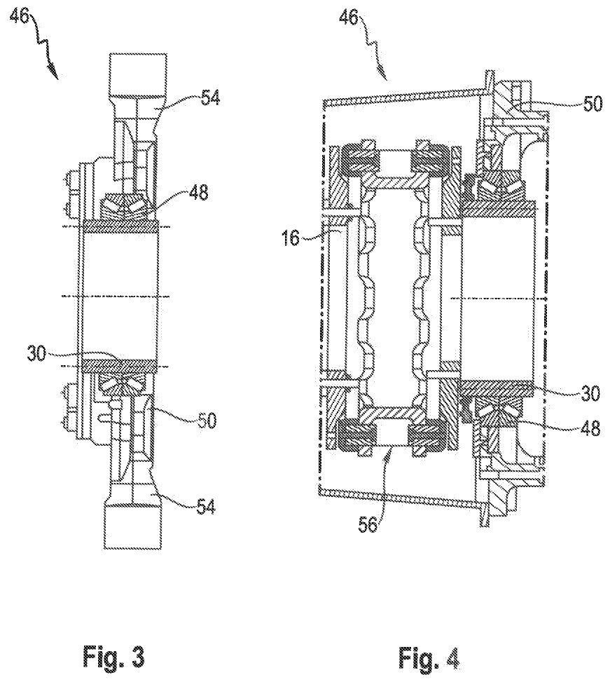

FIG. 3: a schematic sectional view of a first embodiment of a coupling unit for the drive train from FIG. 2,

FIG. 4: a schematic sectional view of a second embodiment of a coupling unit for the drive train from FIG. 2,

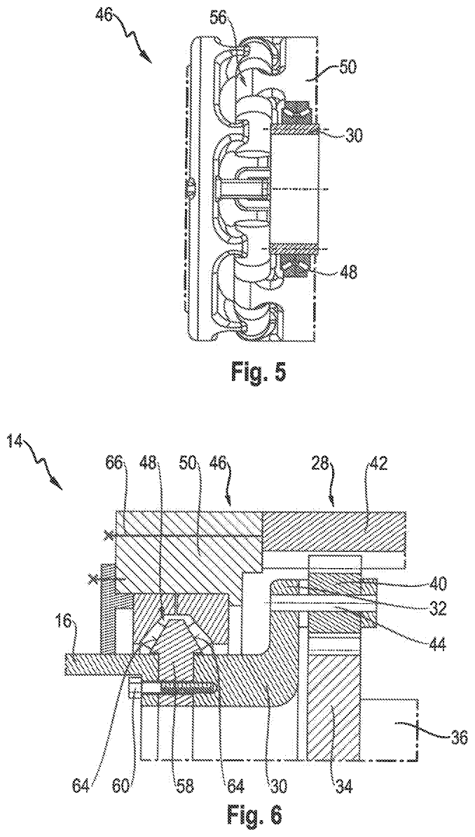

FIG. 5: a schematic sectional view of a third embodiment of a coupling unit for the drive train from FIG. 2,

FIG. 6: a schematic sectional view of a fourth embodiment of a coupling unit for the drive train from FIG. 2,

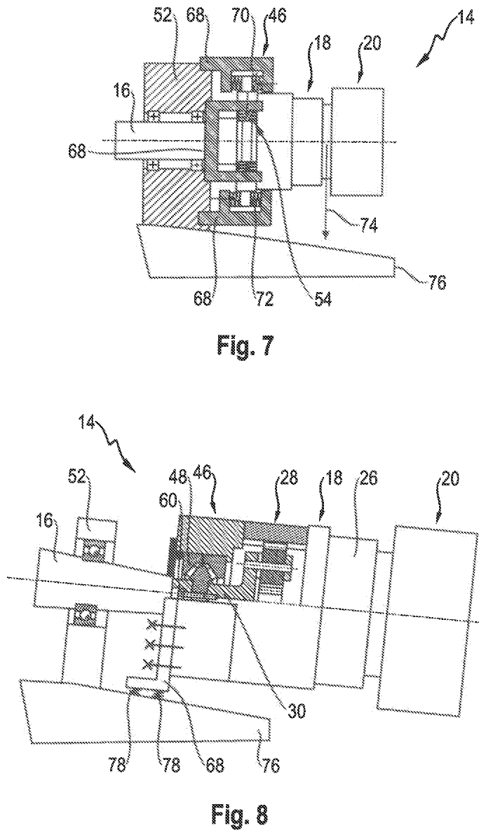

FIG. 7: a schematic basic representation of a fifth embodiment of a coupling unit for the drive train from FIG. 2 in the installed state, and

FIG. 8: a schematic basic representation of the coupling unit from FIG. 6 for the drive train from FIG. 2 in the installed state.

The wind turbine 10 shown in FIG. 1 can be used to generate electrical energy from wind power. For this purpose, the wind turbine 10 has a rotor 12, which, wind-powered by wind, can be made to rotate. The rotor 12 is coupled to a drive train 14. For this purpose, the rotor 12 is connected to a rotor shaft 16, which is coupled within the drive train 14 to a transmission 18 in order to convert the torque introduced via the rotor 12 and the rotor shaft 16. The torque converted in the transmission 18 is supplied to an electric machine which is operated in generator mode and can constitute a generator 20. The electrical energy generated by the generator 20 can be supplied to a rechargeable battery and/or to a power grid. In the Illustrated exemplary embodiment, the drive train 14 is completely accommodated in a nacelle 22, which is attached to an upper free end of a stationary tower 24.

As shown in FIG. 2, the transmission 18, coupled to the generator 20, of the drive train 14 may have multiple planet stages 28 which are accommodated in a transmission housing 26 and of which the input-side planet stage 28 is illustrated without the transmission housing 26. The respective planet stage 28 is in the form of a planetary transmission, in the case of which an input-side torque is introduced via a planet carrier hub 30 of a planet carrier 32 and can be discharged via a sun gear shaft 36 connected to a sun gear 34. The sun gear shaft 36 of the input-side planet stage 28 and the planet carrier hub 30 of the subsequent planet stage 28 may be connected to one another, in particular coincide in one piece. At least one planet gear 40, which meshes both with the sun gear 34 and with a ring gear 42 rotationally fixedly fastened to the transmission housing 26, is rotatably mounted on the planet carrier 32, which in particular has two flanks, at a radial spacing from an axis of rotation 38. In this case, the radially outwardly facing outer side of the ring gear 42 may form a part of the transmission housing 26 that is not separately radially outwardly covered by the rest of the transmission housing 26. The planet gear 40 is rotatably mounted on the planet carrier 32 via a planet pin 44, wherein the planet pin may be in the form of a planet-gear shaft rotationally fixedly fastened to the planet carrier 32 and relatively rotatably mounted in the planet gear 40 or in the form of a planet-gear shaft rotationally fixedly fastened to the planet gear 40 and relatively rotatably mounted in planet-carrier flanks of the planet carrier 32. The planet carrier hub 30, the planet carrier 32, the sun gear 34 and the sun gear shaft 36 of the respective planet stage 28 are hollow, in particular in the form of hollow shafts, so that a pitch tube can be routed through the transmission 18 to the rotor shaft 16 of the rotor 12.

The planet carrier hub 30 can be inserted and/or flange-mounted for example in the coupling unit 46 illustrated in FIG. 3, of the planet carrier 32 of the input-side planet stage 28 of the transmission 18 only the planet carrier hub 30 being shown for the sake of simplified illustration. The coupling unit 46 has a bearing 48, via which the planet carrier hub 30 and thus the planet carrier 32 is mounted in the coupling unit 46. The bearing 48 replaces an otherwise necessary input-side bearing of the planet carrier 32 within the transmission 18, which can thus be omitted. The planet carrier 32 of the transmission 18 is unmounted at least on the rotor side and is only mounted on the rotor side by means of the coupling unit 46, which is separate from the transmission 18. The planet carrier 32 is mounted on the rotor side exclusively within the coupling unit 46. In the embodiment illustrated, the bearing 48 is in the form of a two-row tapered-roller bearing with an O arrangement. Such a bearing 48 can completely mount the planet carrier 32, with the result that no further bearing for mounting the planet carrier 32 is necessary and the bearing 48 of the coupling unit 46 can be the only bearing for mounting the planet carrier 32.

The coupling unit 46 has a coupling housing 50, which is mounted via the bearing 48 on the planet carrier hub 30 of the planet carrier 30 and can be rotationally fixedly fastened to the transmission housing 26 and/or to the ring gear 42 of the transmission 18. In addition or as an alternative, it is possible to connect the coupling housing 50 to a rotor bearing housing 52 for mounting the rotor shaft 16, in particular in limitedly flexible fashion via a spring and/or damper element. The rotor shaft 16 can be fastened indirectly, for example via an intermediate shaft in the coupling unit 46, or directly to the planet carrier hub 30, for example via a flanged connection. In the exemplary embodiment illustrated in FIG. 2, the coupling housing 50 has radially protruding torque arms 54, which can be used to suitably support the torque that is to be transmitted. When the requirement profile for the drive train 14 provides for example a 3-point mounting or a 4-point mounting of the rotor shaft 16, reaction moments such as tilt and/or yaw loads and/or higher torques on the coupling housing 50 and the torque arms 54 can be supported without subjecting the transmission 18 to load. To adapt to such requirement profiles, the length and/or material thickness of the torque arms 54 of the coupling unit 46 can be adapted. An adaptation within the transmission 18 in order to be able to suitably support the torque that is to be transmitted is not necessary and can instead be effected exclusively by means of the correspondingly adapted coupling unit 46.

In the embodiment of the coupling unit 46 illustrated in FIG. 4, by contrast to the embodiment illustrated in FIG. 3 the coupling unit 46 may be provided, in addition or as an alternative to the torque arm 54, with an elastic coupling 56, which in the exemplary embodiment illustrated is rotationally rigid but can be elastically flexible in the axial direction and/or radial direction. This enables a flexible and/or elastic decoupling. When the requirement profile for the drive train 14 provides for axial and/or radial shocks introduced via the rotor shaft 16, these shocks can be damped and/or eliminated by the elastic coupling 56 within the coupling unit 46, without it being necessary to make adaptations in the transmission 18 for this.

In the embodiment of the coupling unit 46 illustrated in FIG. 5, by contrast to the embodiment of the coupling unit 46 illustrated in FIG. 4, the elastic coupling 56 may be provided between the rotor bearing housing 52 and the coupling housing 50. To this end, the elastic coupling 56 may be flexible around the circumference, but in particular axially and/or radially rigidly coupled to the rotor bearing housing 52 and the coupling housing 50. If the requirement profile for the drive train 14 includes sound-sensitive wind turbine locations, excitation frequencies from the generator 20 and/or from the transmission 18 can be decoupled from the rotor shaft 16, and that makes it possible to avoid or at least reduce noise emissions. In addition, torque shocks can be damped and/or eliminated by the elastic coupling 56 within the coupling unit 46, without it being necessary to make adaptations in the transmission 18 for this.

In the embodiment of the coupling unit 46 illustrated in FIG. 6, by contrast to the embodiments of the coupling unit 46 illustrated in FIGS. 3 and 4, the planet carrier hub 30 is mounted in the coupling unit 46 indirectly by means of the bearing 48. Provided axially between the rotor shaft 16 and the planet carrier hub 30 is a transition piece 58, the end face of which is fastened to the rotor shaft 16 and the planet carrier hub 30 by rotor fastening means 60. By contrast to the planet carrier hub 30, the transition piece 58 may form a bearing surface 64 for the bearing 48 on a larger bearing diameter. In the exemplary embodiment illustrated, the bearing 48 is in the form of a two-row tapered-roller bearing in an X arrangement in the manner of a torque bearing, in particular four-point bearing. The coupling housing 50 of the coupling unit 46 is fastened to the transmission 18, in particular to the ring gear 42 and/or to the transmission housing 26, via transmission fastening means 66, wherein the transmission fastening means 66 are easily accessible radially from the outside of the coupling unit 46. The coupling unit 46 can already be preassembled with the rotor shaft 16 and/or with the rotor bearing housing 52 if the rotor-side planet carrier hub 30 of the transmission 18 is inserted into the coupling unit 46. Lastly, the coupling unit 46 can be detachably fastened to the transmission 18 by the transmission fastening means 66, in order to fix the achieved desired relative position.

In the embodiment of the coupling unit 46 illustrated only schematically in FIG. 7, the torque arm 54 is supported against the rotor bearing housing 52 via a supporting foot 68. The supporting foot 68 can be rotationally fixedly fastened, for example screwed, to the rotor bearing housing 52. In addition or as an alternative, the coupling unit 46 can have an axial support 70 with axial spring elements 72 and/or axial damper elements, using which a tilt moment caused by the dead weight 74 of the transmission 18 can be supported against the rotor bearing housing 52 via the same or a further supporting foot 68. Depending on the design of the axial spring element 72 and/or axial damper elements, it is possible to damp and/or eliminate oscillations introduced by the rotor shaft 16 in the axial support 70. The rotor bearing housing 52 is fastened to a machine carrier 76, which can form a base for the transmission 18. The at least one supporting foot 68 can additionally or alternatively be supported against, in particular fastened fixedly in terms of movement to, the machine carrier 76.

In the embodiment of the drive train 14 illustrated in FIG. 8, by contrast to the embodiment of the drive train 14 illustrated in FIG. 7, the rotor shaft 16 in the rotor bearing housing 52 is for example spherically mounted as part of a three-point mounting of the rotor shaft 16. The bearing 60 of the coupling unit 48 can in this respect not only perform the function of mounting the planet carrier hub 30, but additionally perform the function of forming a counterbearing for mounting the rotor shaft 16 in the rotor bearing housing 52, and this counterbearing can support in particular a tilt moment introduced by the rotor shaft 16. In particular, the bearing 60 is in the form of two angular-contact ball bearings in an X arrangement, as a result of which tilt moments that arise can be readily supported against the coupling housing 50. The coupling housing 50 in turn can be supported against a base, in particular the machine carrier 68, via a supporting foot 68, it being possible to provide a spring and/or damper element 78 preferably between the supporting foot 68 and the base and/or machine carrier 68. In addition, it can be provided that the dead weight of the transmission 18 and/or of the generator 20 can also be supported via the same supporting foot 68. Thus, the bearing 48 of the coupling unit 46 can also perform the function of supporting a tilt moment introduced owing to the dead weight of the transmission 18 and/or of the generator 20, wherein preferably the tilt moment introduced into the coupling unit 46 on the input side by the rotor shaft 16 and the tilt moment introduced into the coupling unit 46 on the output side via the planet carrier hub 30 are compensated for at least partially, preferably virtually completely, preferably to an extent of 90% to 100%, in the region of the bearing 48 in the static state and/or in the dynamic state.

1.-15. (canceled)

16. A type series of drive trains, comprising:
a first drive train designed for a first requirement profile and comprising a transmission designed to transmit and convert a torque originating from a rotor shaft, mounted in a rotor bearing arrangement, of a rotor, said transmission comprising an input transmission component which is unmounted on a rotor side for introducing the torque into the transmission and which partially protrudes on the rotor side out of a transmission housing and/or a ring gear of the transmission, the first drive train further comprising a coupling unit which is separate from the rotor shaft, from the rotor bearing arrangement and from the transmission, for permitting a torque-transmitting and rotationally rigid, in particular form-fitting, coupling of the rotor shaft to the input transmission component within the coupling unit, said coupling unit comprising a bearing designed to mount the unmounted input transmission component within the coupling unit, with the input transmission component being mounted on the rotor side exclusively only by the bearing within the coupling unit; and
a second drive train designed for a second requirement profile and comprising a transmission designed to transmit and convert a torque originating from a rotor shaft, mounted in a rotor bearing arrangement, of a rotor, said transmission comprising an input transmission component which is unmounted on a rotor side for introducing the torque into the transmission and which partially protrudes on the rotor side out of a transmission housing and/or a ring gear of the transmission, the second drive train further comprising a coupling unit which is separate from the rotor shaft, from the rotor bearing arrangement and from the transmission, for permitting a torque-transmitting and rotationally rigid, in particular form-fitting, coupling of the rotor shaft to the input transmission component within the coupling unit, said coupling unit comprising a bearing designed to mount the unmounted input transmission component within the coupling unit, with the input transmission component being mounted on the rotor side exclusively only by the bearing within the coupling unit,
wherein the transmission of the first drive train and the transmission of the second drive train are substantially identical and the coupling unit of the first drive train is different than the coupling unit of the second drive train.

17. The type series of claim 16, wherein the first drive train is connected to a first generator and the second drive train is connected to a second generator, wherein the first generator and the second generator are designed for different power profiles.

18. The type series of claim 16, wherein the transmission of the first drive train and the transmission of the second drive train comprise each a planet stage with a planetary transmission including as the input transmission component a planet carrier which faces the rotor shaft and Includes a planet carrier hub protruding toward the rotor shaft and mounted in the coupling unit.

19. The type series of claim 16, wherein the bearing of the first drive train and the bearing of the second drive train bear each directly against the input transmission component, or wherein the coupling unit of the first drive train and the coupling unit of the second drive train include each a transition piece which is fixedly connected to the input transmission component for providing a bearing surface on a bearing diameter which is different than a diameter of the input transmission component, wherein the bearing bears directly against the bearing surface of the transition piece.

20. The type series of claim 16, wherein the bearing of the first drive train and the bearing of the second drive train are each embodied as a plain bearing or rolling bearing, in particular a tapered-roller bearing,

21. The type series of claim 16, wherein the coupling unit of the first drive train and the coupling unit of the second drive train include each a supporting foot designed to transfer a mechanical load to a stationary component, in particular a rotor bearing housing, provided for mounting the rotor shaft, of a rotor shaft arrangement and/or to transfer a mechanical load to the transmission housing and/or the ring gear of the transmission and/or to transfer a mechanical load to a base for supporting the corresponding one of the first and second drive trains.

22. The type series of claim 16, wherein the coupling unit of the first drive train and the coupling unit of the second drive train include each a torque arm designed to support the torque coming from the rotor shaft on a stationary component, in particular a rotor bearing housing, provided for mounting the rotor shaft, of a rotor shaft arrangement and/or to transfer a mechanical load to the transmission housing and/or the ring gear of the transmission and/or to transfer a mechanical load to a base for supporting the corresponding one of the first and second drive trains.

23. The type series of claim 16, wherein the coupling unit of the first drive train and the coupling unit of the second drive train include each an axial spring element and/or an axial damper element designed to flexibly support an axial force, in particular an axial force caused by a dead weight of the transmission.

24. The type series of claim 16, wherein the coupling unit of the first drive train and the coupling unit of the second drive train include each an elastic coupling which is connectable to the rotor shaft and which is rotationally rigid and axially and/or radially flexible,

25. The type series of claim 16, wherein the coupling unit of the first drive train and the coupling unit of the second drive train include each a passage opening, in particular a central passage opening, for passage of a pitch tube between the rotor shaft and the transmission.

26. The type series of claim 16, wherein the coupling unit of the first drive train and the coupling unit of the second drive train include each a lubricant duct designed to swap a lubricant, in particular lubricating oil, between the rotor shaft and the input transmission component.

27. The type series of claim 16, wherein the coupling unit of the first drive train and the coupling unit of the second drive train include each a rotor fastener, which is accessible radially from outside of the coupling unit, for detachable fastening of the coupling unit to the rotor shaft, and/or a transmission fastener, which is accessible radially from outside of the coupling unit, for detachable fastening of the coupling unit to the input transmission component of the transmission.

28. A type series of drive trains, comprising:
a first generator designed for a first power profile;
a first drive train connected to the first generator and comprising a transmission designed to transmit and convert a torque originating from a rotor shaft, mounted in a rotor bearing arrangement, of a rotor, said transmission comprising an input transmission component which is unmounted on a rotor side for introducing the torque into the transmission and which partially protrudes on the rotor side out of a transmission housing and/or a ring gear of the transmission, the first drive train further comprising a coupling unit which is separate from the rotor shaft, from the rotor bearing arrangement and from the transmission, for permitting a torque-transmitting and rotationally rigid, in particular form-fitting, coupling of the rotor shaft to the input transmission component within the coupling unit, said coupling unit comprising a bearing designed to mount the unmounted input transmission component within the coupling unit, with the input transmission component being mounted on the rotor side exclusively only by the bearing within the coupling unit;
a second generator designed for a second power profile; and
a second drive train connected to the second generator and comprising a transmission designed to transmit and convert a torque originating from a rotor shaft, mounted in a rotor bearing arrangement, of a rotor, said transmission comprising an input transmission component which is unmounted on a rotor side for introducing the torque into the transmission and which partially protrudes on the rotor side out of a transmission housing and/or a ring gear of the transmission, the second drive train further comprising a coupling unit which is separate from the rotor shaft, from the rotor bearing arrangement and from the transmission, for permitting a torque-transmitting and rotationally rigid, in particular form-fitting, coupling of the rotor shaft to the input transmission component within the coupling unit, said coupling unit comprising a bearing designed to mount the unmounted input transmission component within the coupling unit, with the input transmission component being mounted on the rotor side exclusively only by the bearing within the coupling unit,
wherein the transmission of the first drive train and the transmission of the second drive train are substantially identical and the coupling unit of the first drive train is different than the coupling unit of the second drive train.

29. A data agglomerate, comprising data packets combined in a common file or distributed across different files for representing a three-dimensional design and/or interactions of all constituent parts provided in a drive train as set forth in claim 16, said data packets being prepared such that when being processed by a data processing device for operating a machine tool for additive manufacturing of an apparatus, to additively produce the constituent parts of the drive train, in particular by 3D printing, and/or when processed by a data processing device for carrying out a technical simulation, to carry out a simulation of a functioning of the drive train and output thus generated simulation results for further use, in particular in order to provide a verification of a fatigue strength as a function of variable loads and/or variable thermal loading.
